(19) United States
(12) Patent Application Publication
(10) Pub. No.: US 2007/0205596 A1
(43) Pub. Date: Sep. 6, 2007

(54) Commercial Product Sales System, Commercial Product Sales-Use Print for Same and Printing Method for the Print

(76) Inventors: Izumi Mizuno, Tokyo (JP); Susumu Isozaki, Tokyo (JP)

Correspondence Address: SCHWEGMAN, LUNDBERG, WOESSNER & KLUTH, P.A., P.O. BOX 2938, MINNEAPOLIS, MN, 55402, US

(21) Appl. No.: 10/594,696

(22) PCT Filed: Mar. 28, 2005
(86) PCT No.: PCT/JP05/05773

§ 371 Date: Sep. 28, 2006

(30) Foreign Application Priority Data
Mar. 30, 2004 (JP) 2004-098549

(51) Int. Cl. B42D 15/00

(52) U.S. Cl. 283/79

(57) ABSTRACT

The purpose of the present invention is to provide a commercial product sales system allowing a purchase and sale of an applicable commercial product just by photographing a desired commercial product out of a seemingly ordinary commercial product advertisement print and transmitting the photographed data. A commercial product sales-use print such as a catalog, flyer, et cetera, is printed by a special sign of a latent optical image almost invisible under a visible light and allowing an image recognition by photographing, together with seemingly common full color images of the commercial product image, product name, price, size, et cetera, per image section carrying advertisement products on the product-sale use prints. When a digital camera photographs an image section of a desired commercial product, the special sign is image-recognized for a display screen visibly imaging and is stored in a memory. The special sign is for example a bar code, QR code, et cetera, and includes a URL of a sales company, advertisement name, advertisement date, product code, et cetera. A person wanting a commercial product purchase is enabled to access to the URL of the sales company, move to a product exhibit page and carry out an input for an order and its confirmation just by transmitting the photographed data.

### TECHNICAL FIELD

The present invention relates to a commercial product sales system, a commercial product sales-use print therefor and a printing method for the print. More specifically, to a commercial product sales system for converting the print into an electric signal, and transmitting, by way of a network, image information which is obtained by photographing commercial product information placed in a commercial product sales-use print by a special printing method, confirming a sale by the receiving party specifying a commercial product according to the image information, and carrying out a purchase and sale of the confirmed commercial product and a billing to the purchasing person.

### BACKGROUND ART

In recent years, a method for ordering a commercial product is one such that a general consumer reviews catalog magazines, newspaper folded advertisement leaflets, or street-hand out flyers, et cetera, instead of purposely visiting a store selling a desired commercial product she or he is looking to order. The consumer then logs on the Internet by using a personal computer (PC) when she or he has found a desired commercial product, accessing the home page by inputting the uniform resource locator (URL) of the sales entity. The consumer then performs a prescribed input procedure such as inputting a product code, the number of pieces, price, and a credit card number, et cetera, thereby ordering the commercial product.

Alternatively, a consumer independently searches directly for a virtual mall (e.g., an electronic mall gathering online shops) on the Internet instead of relying on the above described catalogs, leaflets, and flyers, et cetera, thereby finding out the home page of the store that carries the desired commercial product on the virtual mall and places a request for a purchase by accessing the home page.

In either of the above noted cases, a sales entity first carries out the processing of delivering and billing of the purchase-ordered commercial product when there has been a purchase request for the commercial product. A billing process is usually carried out by the sales entity asking the consumer to input a settlement price and a credit card number as noted above. If, however, the consumer has a concern over the security of inputting the credit card number on the Internet, she or he deposits money in a financial institute such as a bank, a post office, et cetera. Alternatively, she or he mails a prescribed form with the settlement price and a filled in credit card number, or she or he may arrange for a cash-on-delivery settlement.

Furthermore, what has been tried conventionally is printing an infrared emission layer on a print, such as a catalog, or on a plastic board or a magnet layer of a prepaid card, ID card, magnetic card, et cetera, by using an ink composition utilizing an infrared emission fluorescent material for emitting in an infrared wavelength range. The printed information is read out of the infrared emission layer by using an optical reading apparatus, thereby obtaining information such as a characteristic or price, et cetera, of the commercial product and various pieces of personal information, in an attempt to prevent forgery and maintain security (e.g., refer to patent documents 1 and 2).

Techniques have been disclosed for accomplishing a printing as described above, by forming an infrared emission layer by printing or recording an ink composition containing an infrared emission fluorescent material and combining plastic resin on a base film (e.g., refer to a patent document 3).

However, not everyone can participate in the above described sales system. For example, it is hard for an elderly person who has difficulty in reading extremely small characters in a home page on the Internet, and therefore, such a commercial product ordering method is believed to be unsuitable.

Additionally, there are still many people among the middle aged and senior adults who have not yet acquainted themselves with operating a PC, making it hard for them to carry out the above described commercial product ordering system on the Internet.

Even if a person is fully accustomed to operating a PC and is capable of carrying out a commercial product ordering system on the Internet, a tremendous amount of time and effort is required for the PC operation, such as inputting the URL for a shopping site, searching for a screen which carries desired product information from the opened top page, and manual operations of input keys and a mouse on the PC.

Even if the consumer finds a desired product, matches a product number with a product picture in the printed catalog, for example, and then places a purchase order, the ensuing procedure is still cumbersome as described above. Thus, leaving as being far from convenient.

Furthermore, the method for preventing forgery and maintaining security by printing with an ink containing an infrared emission fluorescent material is simply for the purpose of obtaining information secretly and legitimately by required personnel without exposing the information to an irrelevant person, and no further usage has been developed.

[Patent document 1] laid-open Japanese patent application publication No. Sho 53-009600

[Patent document 2] registered Japanese patent No. Sho 61-018231

[Patent document 3] laid-open Japanese patent application publication No. 07-188599

### DISCLOSURE OF INVENTION

In consideration of the above described conventional situation, the purpose of the present invention is to provide a commercial product sales system, a commercial product sales-use print used therefor and a printing method for the print which enable execution of a trade of a commercial product just by photographing a desired commercial product from a commercial product advertisement print looking ordinary at a glance, which is printed by a special printing method and transmitting the photographed data.

First of all, a printing method for a commercial product sales-use print according to a first invention is configured to print at least a visual image of a commercial product and to print commercial product information overlapping the visual image of the commercial product which relates to the commercial product of the visual image. The commercial product information may be made up of a latent optical image that is almost invisible under visible light and becomes a visible image in a photograph of the print.

This configuration is capable of forming a color image, including black made up of three subtractive primary color inks using three image forming units which form respective mono color images by the three primary colors, by using a common printing apparatus comprising four image forming units for respectively forming four kinds of mono color images of three subtractive primary color inks and a black ink for example, and printing the latent optical image by an ink for printing a latent optical image that is invisible under visible light and becomes a visible image by photographing, using an image forming unit provided for forming a mono color image by the black ink.

Next, a printing method for a commercial product sales-use print according to a second invention comprises printing at least a visual image of a commercial product and printing a code, for indicating commercial product information relating to the commercial product of the visible image, embedded within the pixels of the visible image of the commercial product. This configuration may be such that a code for indicating the commercial product information is either a bar code or a two-dimensional code.

The printing method for a commercial product sales-use print, according to the above described first and second inventions, is configured such that the commercial product information includes either, or the entirety of, the URL, advertisement name, advertisement date, and/or product code of the sales entity of the commercial product, for example.

A commercial product sales-use print according to a third invention is configured to print thereon at least a visible image of a commercial product, and commercial product information, which relates to the commercial product of the visible image, made up of a latent optical image that is almost invisible under visible light and becomes a visible image in a photograph of the print, per image section, the number of which is according to that of categories of the commercial products.

The commercial product information printed in the latent optical image may include information such as the URL of the sales entity, advertisement name, advertisement date, and/or product code of the commercial product, for example. The commercial product information may be printed by overlapping a latent optical image with a visible image of the commercial product, a visible image of a price display which is printed together with the commercial product and/or an unprinted part of the print within one image section, for example. In some cases, the unprinted part is preferably the unprinted part of the adjacent to a visible printing of a size display which is printed with the commercial product, for example.

A commercial product sales-use print according to a fourth invention is configured to print thereon at least a visible image of a commercial product, and a code for indicating commercial product information relating to the commercial product of the visible image by being embedded so as to be mixed with the pixels of the visible image of the commercial product, and is printed per image section, number of which is according to that of categories of commercial products. The code indicating the commercial product information is a bar code or a two-dimensional code for example.

The commercial product information includes either, or the entirety of, the URL of the sales entity, advertisement name, advertisement date, and/or product code of the commercial product, for example.

Next, a commercial product sales system according to a fifth invention comprises the procedure of photographing the image section of one of the above described commercial product-use prints which contains the desired commercial product and placing an order of the photographed commercial product by converting the photographed image data into an electric signal and transmitting it by way of a predetermined telecommunication network. The order is established by transmitting a response to image information of a prescribed format which is transmitted corresponding to the order of the commercial product by way of the telecommunication network.

This is configured such that the response to image information of the prescribed format includes at least the name, street address and/or telephone number of a party sending the response.

The photographing of the image section may be carried out by a cellular phone equipped with a camera, a personal digital assistance (PDA) equipped with a camera and telecommunication function, and/or a digital camera, for example. The transmission may be carried out by a cellular phone equipped with a camera, the personal digital assistance (PDA) equipped with a camera and telecommunication function, or a personal computer comprising a telecommunication function, on which the image data is loaded from the digital camera.

Next, a commercial product sales system according to a sixth invention comprises a server connected to a predetermined telecommunication network, wherein the server receives an electric signal transmitted by way of the telecommunication network as a result of converting image data into the electric signal upon the photographing of the image section which prints the desired commercial product that is contained in either of the above described commercial product-use prints. The server receives an order of a specified commercial product by identifying the commercial product in the photographed image section based on commercial product information contained in the image data processed from the received electric signal. The server transmits image information by a prescribed format to a party transmitting the electric signal by way of the telecommunication network and confirms that data sent by the transmitting party based on the transmitted image information correctly corresponds to the prescribed format. The server then carries out the processing of a delivery instruction of the commercial product to the transmitting party and charging price of the commercial product based on the confirmed data.

In some cases, the above noted commercial product-use prints are preferably distributed to an unspecified number of consumers or to consumers wanting to receive the distributed print.

### BRIEF DESCRIPTION OF DRAWINGS

FIG. 1 shows an overall comprisal of a commercial product sales system according to a first embodiment of the present invention;

FIG. 2 is a block diagram illustrating a system comprisal of a server (hardware) at a commercial product sales company;

FIG. 3 exemplifies a commercial product sales-use print used for a commercial product sales system;

FIG. 4A exemplifies an aspect of printing an image section for printing a living room table as one example from among image sections of a commercial product sales-use print (part 1);

FIG. 4B exemplifies an aspect of printing an image section for printing a living room table as one example from among image sections of a commercial product sales-use print (part 2);

FIG. 4C exemplifies a printing of a special sign made up of a latent optical image in the printing aspect shown by FIG. 4A;

FIG. 4D exemplifies a printing of a special sign made up of a latent optical image in the printing aspect shown by FIG. 4B;

FIG. 5A exemplifies another aspect of printing an image section for printing a living room table (part 1);

FIG. 5B shows an enlargement of a printing example of an embedded special sign in the printing aspect shown by FIG. 5A;

FIG. 5C exemplifies another aspect of printing an image section for printing a living room table (part 2);

FIG. 5D shows an enlargement of a printing example of an embedded special sign in the printing aspect shown by FIG. 5C;

FIG. 6 exemplifies a printing of a special sign as a visible image in a degree of maintaining a beauty as an image of a commercial product advertisement;

FIG. 7 illustrates a processing procedure carried out by using a commercial product sales system, viewed from a purchaser, for purchasing a commercial product according to the present invention;

FIG. 8 is a flow chart showing a processing operation for a commercial product purchase and sale which is processed by a telecommunication between a Web browser on a cellular phone equipped with a camera and a server at a commercial product sales company;

FIG. 9 shows a state of a change in management data processed on the server side in the processing shown by the above noted flow chart;

FIG. 10A illustrates an example of a screen display (part 1) displayed on the display screen equipped by a cellular phone 5 equipped with a camera by a Web browser in the processing shown by the above noted flow chart;

FIG. 10B illustrates an example of a screen display (part 2) displayed on the display screen equipped by a cellular phone 5 equipped with a camera by a Web browser in the processing shown by the above noted flow chart;

FIG. 11A exemplifies a screen display (part 1) displayed on the display screen comprised by a cellular phone equipped with a camera by a Web browser in the processing shown by the above noted flow chart;

FIG. 11B illustrates a state of a data exchange in the middle of a display processing for the display screen comprised by a cellular phone equipped with a camera by a Web browser in the processing shown by the above noted flow chart;

FIG. 11C exemplifies a screen display (part 2) displayed on the display screen comprised by a cellular phone equipped with a camera by a Web browser in the processing shown by the above noted flow chart;

FIG. 12 shows a state of transferring image data wherein an image of a special sign is recognized; and

FIG. 13 exemplifies a commercial product advertisement attached by a special sign display in a television screen.

### DESCRIPTIONS OF COMPONENT NUMBERS

1 telecommunication network
2 server at a commercial product sales company
3 (server at) a credit card company
4 (server at) a credit card clearance company
5 (5-1, 5-2) cellular phone equipped with a camera
6 network adaptor
7 CPU (central processing unit)
8 ROM (read only memory)
9 RAM (random access memory)
11 HD (hard disk)
12 I/F (interface) unit
13 external storage apparatus
14 monitor
15 keyboard/mouse
16 terminal
17 commercial product sales-use print
18 image section
19 image printing (visible image) part of a living room table
21 printing (visible printing) part of a price display
22 size display frame
23 one corner of a living room table
24 bar code
25 hand
26 bar code
27 login certification screen
28 login frame
29 triangle cursor indication mark
30 (30-1 through 30-5) management data
31 login screen to a sales desired screen
32 product name
33 product image
34 product unit price
35 charging form screen
36 input frame
37 sales completion screen
38 upper display area
39 lower display area

### BEST MODE FOR CARRYING OUT THE INVENTION

The following is a detailed description of the preferred embodiment of the present invention while referring to the accompanying drawings.

### First Embodiment

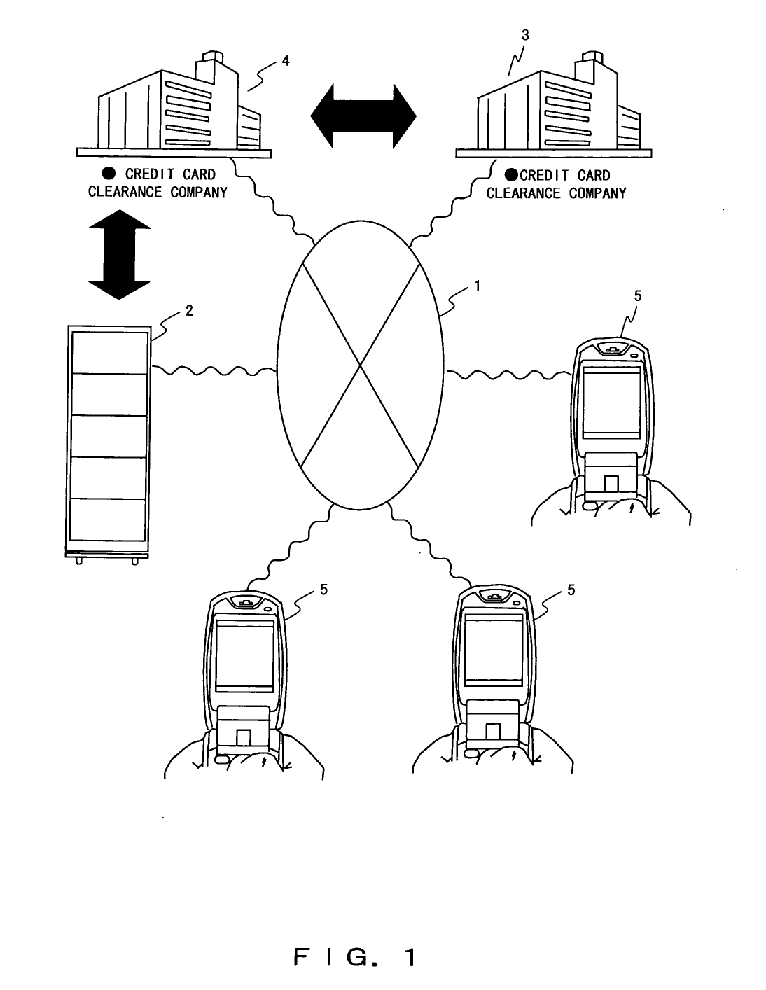

FIG. 1 shows an overall comprisal of a commercial product sales system according to a first embodiment of the present invention. As shown by FIG. 1, the commercial product sales system according to the present embodiment comprises a telecommunication network 1, such as the Internet, connected by a server 2 at a commercial product sales company, (a server at) a credit card company 3, (a server at) a credit card clearance company 4, and a large number of information terminal equipments 5 each equipped with a camera and a transmission function.

The above described information terminal equipment 5 equipped with a camera and a transmission function comprehends a cellular phone equipped with a camera, a personal digital assistance (PDA) equipped with a camera and a transmission function, a mobile computer equipped with a camera and a transmission function, and/or a PC equipped with a transmission function which is loaded with imaged data of a digital camera, for example. The following description uses a cellular phone 5 equipped with a camera to represent the terminal equipment.

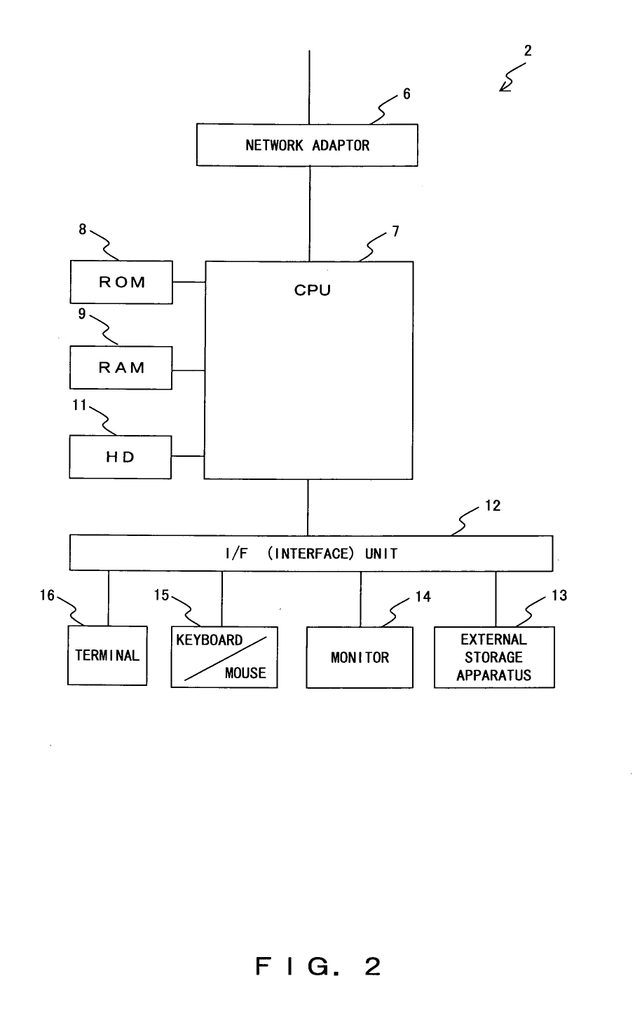

FIG. 2 is a block diagram illustrating a system comprisal of the server 2 (hardware) at the commercial product sales company. Referring to FIG. 2, the server 2 comprises a CPU (central processing unit) 7 connected to the telecommunication network 1 shown by FIG. 1 by way of a network adaptor 6, and a ROM (read only memory) 8, a RAM (random access memory) 9, an HD (hard disk) 11, and an I/F (interface) unit 12 which are connected to the CPU 7.

The ROM 8 stores an OS (operating system: basic software), and the RAM 9 at least comprises a program area, a data area, and a temporary area (i.e., a work area).

The HD 11 stores a program for controlling the entirety of the server 2 and/or a series of servers (i.e., a series of software), e.g., Web server, file server, communication server, data base server and/or mail server.

The HD 11 further stores other various applications, such as a commercial product information data base, a customer management data base, a commercial product delivery and/or a charging relations management data base, for example.

Incidentally, while the above described various servers (i.e., software) functions may be accomplished by one server machine, it may be preferable to install a plurality of server machines for a distributed processing of server functions because a processing speed is slowed down with an increased number of clients due to a concentrated load proportionate with the number thereof.

The I/F unit 12, comprising various interfaces such as a plurality of USBs (universal serial bus), serial I/F and parallel I/F, is connected by an external storage apparatus 13, monitor 14, keyboard &mouse 15 and terminal 16.

The external storage apparatus 13 may be one or more of an externally provided HD, an MO (magneto optical disk), and/or a CD R/W (compact disk read/write memory), for example, and is used for various data loading, installing various applications, or various data backups.

The monitor 14 may be, for example a CRT (cathode ray tube), an LCD (liquid crystal display), and/or a plasma display, and displays various data processing contents in the server 2, man-machine interfaces with an operator, and various necessary displays.

The keyboard & mouse 15 is used for input operations by an operator when instructing the server 2 (i.e., software) to update data or an application.

The terminal 16 is an exclusive terminal apparatus or a PC which is operated independently from the monitor 14 or the key board & mouse 15, and is capable of handing an operating result over to the server 2 (i.e., software) and receiving data from the server 2 (i.e., software)

The CPU 7, operating based on the OS stored in the ROM 8, reads various servers and applications stored by the HD 11 to a program area of the RAM 9, reads various data base and various data out of the HD 11 to a data area of the RAM 9 for carrying out a processing according to the aforementioned software, and communicates with a Web browser of a client which has access to the server 2 while storing necessary intermediate or temporary data in a temporary area on the RAM 9.

### Second Embodiment

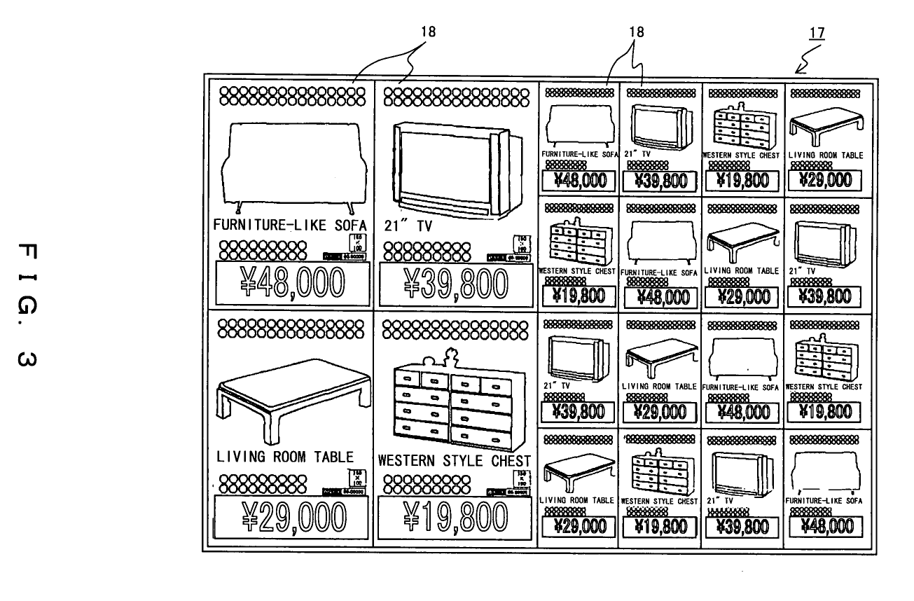

FIG. 3 exemplifies a commercial product sales-use print used for the commercial product sales system. The commercial product sales-use print 17 shown by FIG. 3 is a commercial product advertisement for sales promotion, such as a newspaper folded-in advertisement or a flyer handed out in a street.

The commercial product sales-use print 17 is printed with a product name, price and a vertical and horizontal size for a selected product, for example, together with a commercial product image by a common full color visible image, for each of image sections 18, number of which is according to that of product series.

The commercial product sales-use print 17 further contains a special sign comprising a latent optical image that is invisible under a visible light and becomes a visible image in a photograph of the print.

Incidentally, although FIG. 3 shows a single sheet of a commercial product sales-use print 17, the embodiment also applies to other types of advertisements such as, one page of a bound book of catalogs for distributing to a person with a membership or an interested person, and/or a page of a commercial product advertisement folded in a magazine.

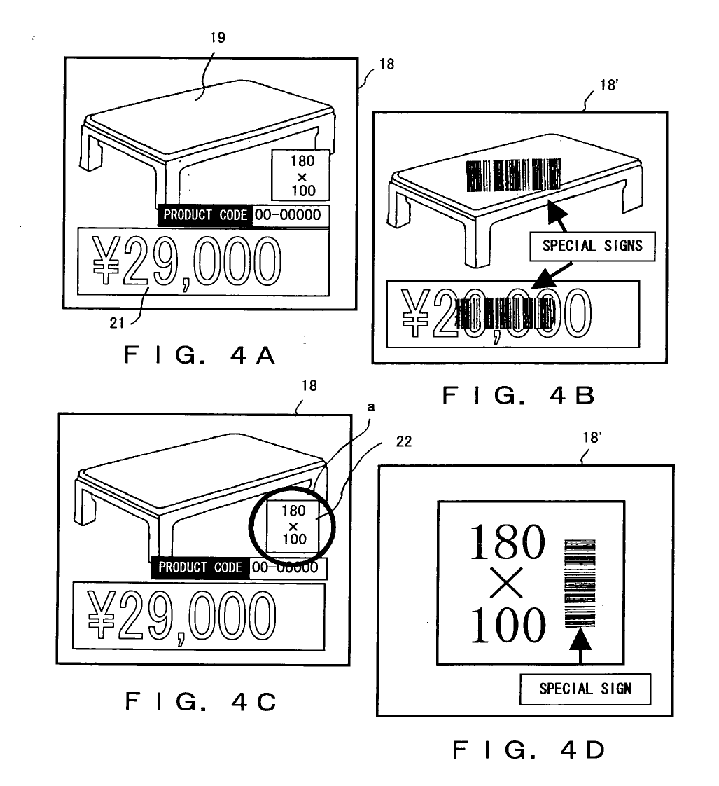

FIG. 4A exemplifies an aspect of printing an image section for a living room table advertisement as one example from among image sections of a commercial product sales-use print (part 1).

FIG. 4B exemplifies another aspect of printing an image section for a living room table advertisement as one example from among image sections of a commercial product sales-use print (part 2).

FIG. 4C exemplifies a printing of a special sign made up of a latent optical image in the printing aspect shown by FIG. 4A.

FIG. 4D exemplifies a printing of a special sign made up of a latent optical image in the printing aspect shown by FIG. 4B.

FIG. 4B shows an image 18′ in which a printing of the special sign comprising a latent optical image is turned into a visible image in a photograph of the image section 18 shown by FIG. 4A when photographed with a digital camera.

As shown by FIG. 4B, this example shows an image printing (of a visible image) part 19 of the living room table shown by FIG. 4A and an example of special signal printed overlapping the living room table part 19 and a printing (of a visible print) part 21 of the price display.

Note that FIG. 4B exemplifies the case of the special signals being bar codes. As such, the printing of the special signs printed as shown by FIG. 4A are printed using a special ink which is almost invisible under a visible light and that becomes visible in a photographed image when photographed with a digital camera.

And FIG. 4D shows an image 18′ of the size display frame 22, which is printed with the length and width sizes of the living room table shown by the circle “a” in FIG. 4A, when photographed by a digital camera.

The drawing shown by FIG. 4D exemplifies a bar code printing as a special sign, now visible, which is printed in an unprinted part (i.e., a part of white background) within the size display frame 22 shown by FIG. 4A. ¥¥¥¥

In this case also, the special sign printing printed as shown by FIG. 4C is printed with a special ink which is almost invisible under the visible light as described above, and accordingly becomes a visible image when photographed with a digital camera.

In either embodiment shown in FIG. 4B or 4D, the information indicated by the bar code can be the information for the purpose of identifying a commercial product, including the URL of the sales company, advertisement name, advertisement date and/or a product code, et cetera, for example.

The product code, while not shown herein, is linked with the data record of the corresponding commercial product within the data base storing product information which is stored by the HD 11 comprised by the server 2 (i.e., hardware).

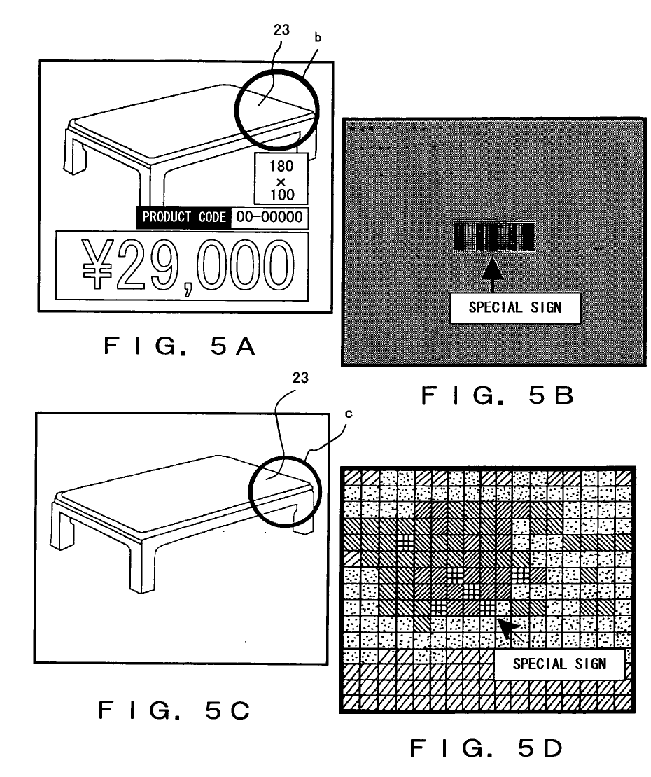

FIGS. 5A and 5C each exemplifies another aspect of printing an image section 18 for printing the same living room table 19.

FIGS. 5B and 5D each show an enlargement of a printing example of an embedded special sign in the printing aspect shown by FIGS. 5A and 5C respectively.

The special sign printing in this case is printed with an ink which is visible under a common visible light, it is, however, hardly visible because it is printed by embedding within the image, that is, printed in an inconspicuous way.

FIG. 5B shows an enlargement of a printing of one corner 23 of the living room table indicated by a circle “b” shown by FIG. 5A. As shown by FIG. 5B, a bar code is printed by embedding it in a manner that the thickness of the finest bar of the bar code is in a size equal to the size of one pixel dot of the printing within the image.

The image of the living room table is a full color printing, as the same as other product images, which is actually printed with a color tone having a gradation as shown by FIG. 5D.

An existence of the bar code, within the aforementioned image, of the finest bar that is embedded in a size equaling to that of one pixel dot of the printing, is almost unrecognized by a naked eye.

However, an image recognition processing is capable of recognizing every pixel dot, and therefore, is capable of processing the data by recognizing the bar code inside the full color print.

FIG. 5D shows an example of an embedded printing of an inconspicuously distributed two-dimensional code, configured to utilize the fact that the one corner 23 of the living room table indicated by the circle “c” shown by FIG. 5C is a color tone with a gradation as described above.

Such two-dimensional codes may include a QR code, a micro QR code (provided by Denso Wave Incorporated), a PDF 417 (provided by Symbol Technologies, Inc.), a DataMatrix (provided by CI Matrix, Inc.), and/or a MaxiCode (provided by United Parcel Service, Inc.), for example.

These two-dimensional codes are capable of expressing the same printing information as a conventional bar code by printing in an area with the size of one thirtieth ( 1/30) of a conventional bar code size, for example.

Incidentally, although the commercial product sales-use print 17 shown by FIG. 3 exemplifies electric appliances or pieces of furniture as advertisement commercial products, the print may also apply to targeted commercial products to be promoted for sales including material and immaterial valuable things that are sellable, including goods to be sold, an admittance ticket for an entertainment, a pass, a ticket, a boarding pass, and/or an accommodations reservation, for example.

### Third Embodiment

The following describes a printing method for the above described commercial product sales-use print 17. The method for printing the commercial product sales-use print 17, while not specifically shown herein, can use various printing machines.

For example, some printing machines include a web offset press, a sheet-feed offset press, a relief printing machine, a center impression-, stack-, and line-type flexographic presses, a screen printer, a gravure printing machine, a laser printer, an inkjet printer, and/or a thermal transfer printer.

In either case, a color printing in most cases uses a total of four color inks, i.e., magenta, cyan and yellow, which are the three primary colors of a subtractive mixture of color, and black for use in a pitch black part of a character or image.

This method, while adding one process in a printing process, has an advantage of making expressions of a black part of an image clearly distinguished and allow the black part to be made with a lower cost black ink, instead of using the above noted three color inks, and therefore is economical.

Nonetheless, a process of three colors only, i.e., magenta, cyan and yellow, expressing black as well as a full color makes the printing process time shorter and the configuration of a printing machine simpler, and therefore is very difficult to compare with a four-color process in terms of cost saving.

In either case, the image forming unit of each color prints a spectroscopic image according to an applicable color ink by overlapping with a color which has been previously printed.

In the case of using a special ink, which is invisible under a visible light, as shown by FIGS. 4B and 4D, using a printing machine which usually uses four color inks and printing with a special ink using an image forming unit conventionally used for black, which is usually the last overlapping printing, makes it possible to accomplish a quick printing.

Alternatively, printing of the special ink may be carried out by a separate printing machine or a separate printing process. In any event, although the printing process uses a special ink, a special printing machine will need not be used.

Additionally, a normal printing of the special sign in a visible image, is possible as long as it does not spoil the beauty of an image of a commercial product advertisement.

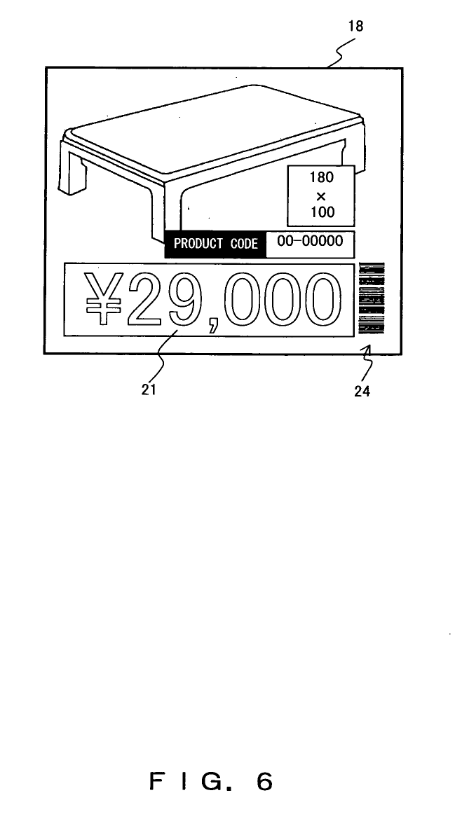

FIG. 6 exemplifies a printing of a special sign in a visible image in a degree of maintaining a beauty as an image of a commercial product advertisement.

In the example shown by FIG. 6, a bar code 24 is printed small alongside a price display printing part 21 within the image section 18. As such, the bar code 24 printed nearby a price display and is visually ignored by the consumer, and not very conspicuous. Therefore, the print maintains the beauty of the entire image because such a bar code 24 is mostly generally regarded as indicating information relating to a commercial product price independent of the actual information content.

### Fourth Embodiment

The next description is of a commercial product sale and purchase carried out by the commercial product sales-use print 17, as exemplified by FIG. 3, which is printed by the above described printing method, and the system comprisal as shown by FIGS. 1 and 2.

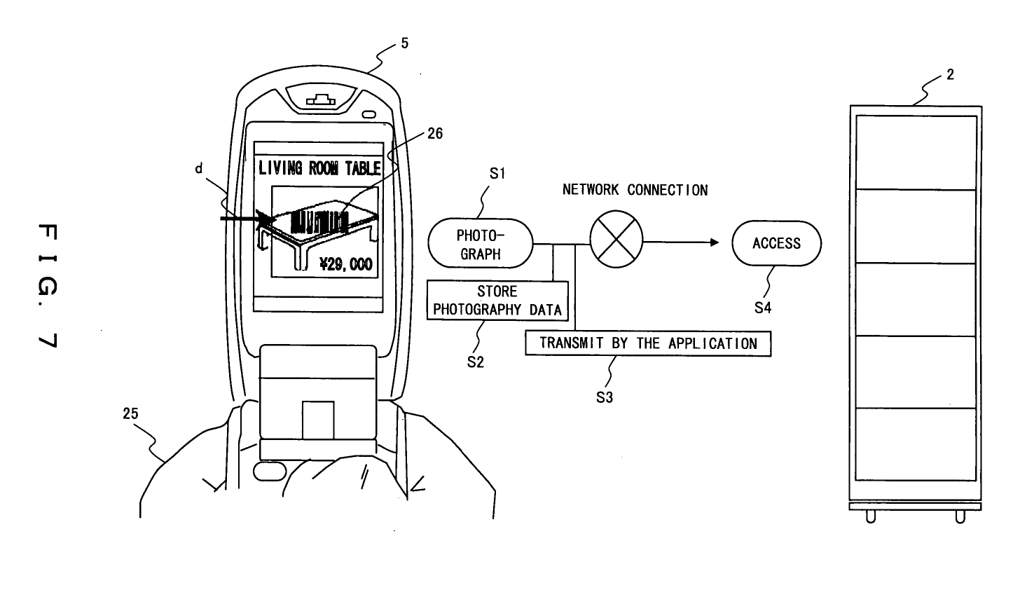

FIG. 7 illustrates a processing procedure carried out by using a commercial product sales system, viewed from a purchaser, for purchasing a commercial product according to the present invention.

As shown by FIG. 7, a purchaser looks at an image of a commercial product printed in each image section 18 of the commercial product sales-use print 17 and photographs a desired commercial product. For example, the consumer photographs an image section 18 carrying a living room table with a cellular phone 5 equipped with a camera held by the hand 25 (S1).

Next, the display screen of the cellular phone 5 equipped with a camera displays an image of the image section 18 carrying the just photographed living room table and at the same time displays an imaged bar code 26, as a special sign, by overlapping with the image of the living room table as indicated by the arrow “d” shown by FIG. 7.

The images of the living room table and the bar code 26 are stored by the memory of the cellular phone equipped with a camera as photograph data (S2).

Then, when the purchaser presses a transmission button on the cellular phone 5 equipped with a camera, a commercial product purchase-use application by an e-mail is initiated which is either built in or preinstalled in the cellular phone 5 equipped with a camera. The image of the bar code stored by the memory is then deciphered and converted to information data and a URL of the commercial product sales company included in the converted information data is read out by the commercial product purchase-use application.

Then, a Web browser of the cellular phone 5 equipped with a camera is started, the above obtained URL is transmitted to the telecommunication network 1 along with a commercial product code and other information contained by the deciphered information data according to a protocol contained by the above described URL (S3). An access is carried out to the top address indicated by the URL, which is directed to the server 2 at the commercial product sales company (S4).

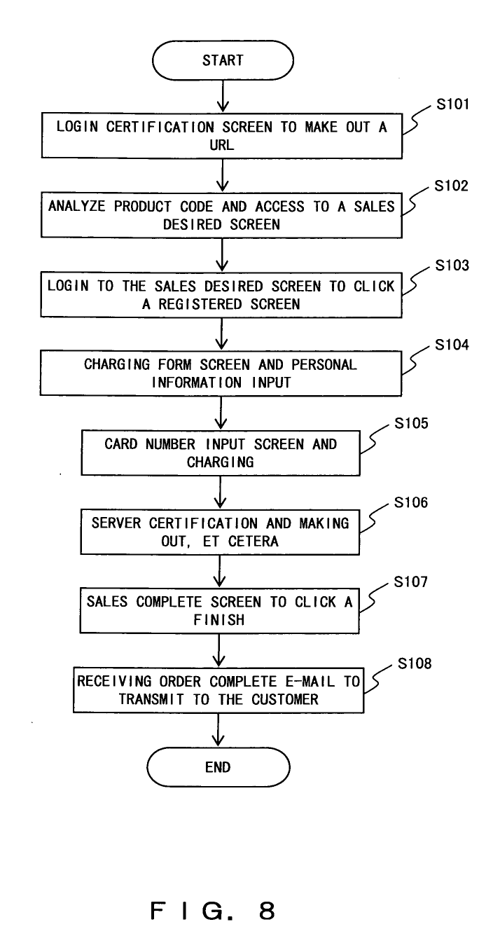

FIG. 8 is a flow chart showing a processing operation for a commercial product purchase and sale that is processed by a telecommunication between a Web browser on a cellular phone 5 equipped with a camera and a server 2 at a commercial product sales company.

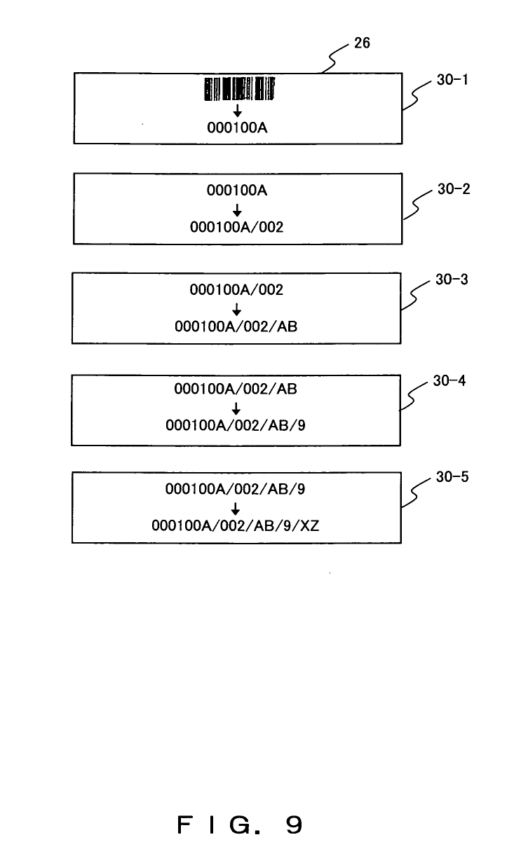

FIG. 9 shows a state of a change in management data processed on the side of server 2 in the processing shown by the above noted processing.

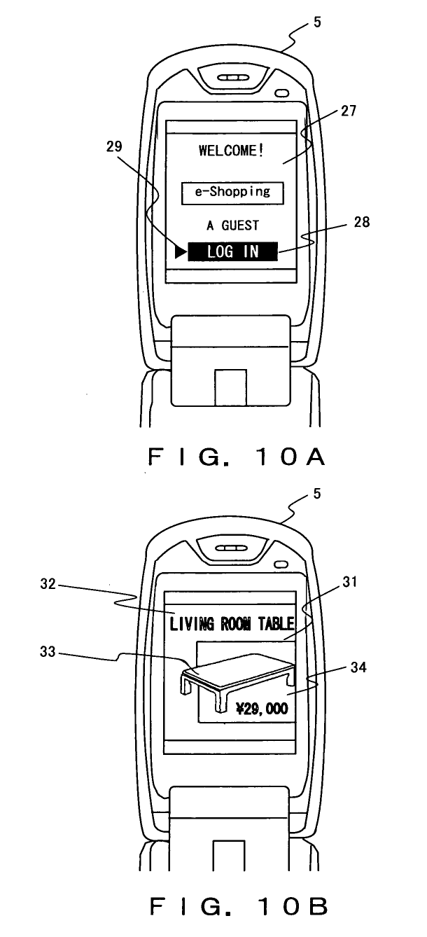

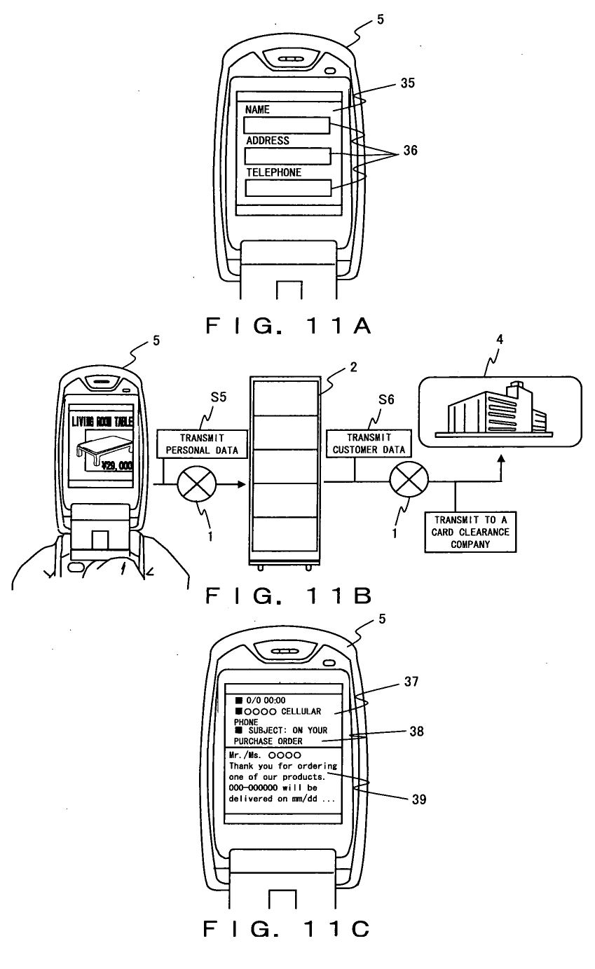

FIGS. 10A, 10B, 11A, 11B and 11C show examples of display screens displayed in the screen display comprised by the cellular phone 5 equipped with a camera by the Web browser and illustrate states of data exchanges in the process.

The following description is of an operation for processing a commercial product purchase and sales based on FIG. 8, while referring to the above noted FIGS. 9, 10A, 10B, 11A, 11B and 11C.

First, the Web browser of the cellular phone 5 equipped with a camera shown by the above noted FIG. 7 (simply “Web browser” hereinafter) accessing to the server 2 at the commercial product sales company (simply “server 2” hereinafter) lets the server 2 transmit the data of a login certification screen set up for the accessed top page to the Web browser. The Web browser then displays the login screen in the display screen comprised by the cellular phone 5 equipped with a camera (the former part of S101).

FIG. 10A exemplifies a login certification screen displayed by the display screen of the above described cellular phone 5 equipped with a camera. The login certification screen displayed by the cellular phone 5 equipped with a camera shown by FIG. 10A displays, respectively from the top to bottom, “Welcome!”, framed “e-shopping”, “Guest” and framed “login”.

Also displayed are the triangle cursor indication mark 29 to the left of the frame (i.e., a login frame 28) displaying the character “Login” and the login frame 28 being already in a darker color (or in a reversed color hue) inside the frame, indicating the login frame 28 being a selected button.

At this point, the purchaser pressing the confirmation button, which is commonly located at the center of the cross cursor key on the cellular phone 5 equipped with a camera functions as pressing the selection button for logging in, thereby transmitting the login selection signal to the server 2.

Having received the login selection signal, the server 2 confirms the intention of the purchaser for logging in and makes out the URL transmitted at the time of the access (the latter part of S101).

This processing is the one for identifying a directory following the top page address of the above described URL, a further directory or a file name following the aforementioned directory and is also the one for reading out readout information data out of the bar code transmitted together with the URL.

As described in the example above, the readout information data of a bar code includes a product code (i.e., the product code of the living roomtable according to the present embodiment).

Here, the management data 30 (specifically, 30-1) shown by FIG. 9 records a product code, e.g., “000100A”, read by the server 2 out of the readout information data of the bar code 26 shown by FIG. 7.

Then, referring to FIG. 8, the above noted product code “000100A” is analyzed and a sale desired screen of a data base stored by the HD 11 is accessed based on the analysis (S102).

Then, the sale desired screen data read out by the access is transmitted to the Web browser, and a sale desired screen 31 is displayed in the display screen of the cellular phone 5 equipped with a camera as shown by FIG. 10B. That is, a login to the sale desired screen 31 is carried out (the former half part of S103).

The sale desired screen 31 of the cellular phone 5 equipped with a camera shown by FIG. 10B displays a product name 32, i.e., “Living room table”, placed at the upper left, a product image 33 thereof placed at the center and a product unit price 34, i.e., “29,000 yen”, placed at the bottom left.

Also, in this processing, on the server 2 side, a code indicating that the sale desired screen data has been transmitted to the management data 30 (30-2) is added and recorded following the product code “000100A”.

Here, if the purchaser can confirm that the product image 33 of the above noted living room table body displayed in the sale desired screen 31 of the cellular phone 5 equipped with a camera is the same as the image transmitted by him or her by photographing as shown by FIG. 7 out of the commercial product sales-use print 17, he or she clicks the center confirmation button of the cross cursor key in order to register the above described display content of the sale desired screen 31 (the latter part of S103).

The confirmation signal by the clicking is transmitted to the server 2 by the Web browser. Having received the confirmation signal, the server 2 transmits data of a charging form screen to the Web browser which, having received the charging form screen data, displays the charging form screen in the display screen of the cellular phone 5 equipped with a camera (the former part of S104).

The charging form screen 35 displayed on the cellular phone 5 equipped with a camera shown by FIG. 11A displays the character strings, from the top to bottom, “Name”, “Street Address” and “Phone Number” with the respective input frames 36 being displayed below each character string.

Also in this processing, over at the server 2, a code “AB” indicating the fact that the charging form screen data has been transmitted is recorded in the management data 30 (i.e., 30-3) as shown in FIG. 9, by being added behind the product code “00100A” and sale desired screen transmission code “002” which are indicated by the management data 30-2 shown by FIG. 2.

Then, referring back to FIG. 8, the purchaser inputs the name, street address and phone number as the personal information in the respective input frames 36 according to the charging form screen 35 shown by FIG. 11A (the latter part of S104).

The input personal information is transmitted to the server 2 by the Web browser, and the server 2, having received the personal information, then transmits data of a card number input screen to the Web browser. The Web browser displays the card number input screen in the display screen of the cellular phone 5 equipped with a camera based on the received data of the card number input screen (the former half of S105).

The card number input screen, while not specifically shown, first displays a plurality of credit card companies in a selectable manner. This is for selecting either one of the plurality of credit card companies, followed by clicking the confirmation button, then inputting a credit card number used for paying for the commercial product price in the displayed credit card number input frame and clicking the confirmation button.

The input card number is transmitted to the server 2 by the Web browser, and the server, having received the card number, transits itself to a charging processing (the latter part of S105).

The charging processing carries out a certification procedure by the data exchange shown by FIG. 11B. That is, the personal data made up of the name, street address, telephone number and credit card number is transmitted to the server 2 by the Web browser of the cellular phone 5 equipped with a camera by way of the telecommunication network 1 (S5).

The server 2 records the personal data together with the data such as the advertisement name, advertisement date, and/or product code, etcetera, which are deciphered from the above described bar code as newly generated code in a designated data base, followed by transmitting these pieces of data together with the company name, i.e., the commercial product sales company, to the credit card clearance company 4 by way of the telecommunication network 1 (S6).

The credit card clearance company 4 confirms that the received credit card number is the one issued to the person of the name, street address and telephone number which have been received, followed by transmitting a card number certification signal to the server 2. By this, the server 2 confirms the certification of the credit card number (S106).

In the server 2, the management data 30 (specifically 30-4) records a code “9”, which indicates that the credit card number is certified. This is code added following the product code “00100A”, sales desire screen transmission code “002” and charging form screen transmission code “AB” which are indicated by the management data 30-3 shown by FIG. 9.

Based on the above described certification confirmation, the server 2 then transmits the data for a sale completion screen to the Web browser which displays the sale completion screen in the display screen of the cellular phone 5 equipped with a camera based on the data for the received above described sales completion screen (the former part of S107).

As shown by FIG. 1C, the sales complete screen 37 of the cellular phone 5 equipped with a camera displays the date and time of establishing the order, the telephone number of the cellular phone 5 equipped with a camera which has been used for the request and the information that the preceding telecommunication is relating to a commercial product order in the upper display area 38, and the address by the name of the purchaser with his or her term of respect, a message thanking the consumer for the order, the ordered commercial product, the home delivery date of the product, et cetera, in the lower display area 39.

When confirming that the display contents of the sales completion screen 37 are correct, the purchaser clicks the confirmation button at the center of the cross cursor key (the latter half of S107).

The clicking prompts the Web browser to transmit a sales completion confirmation signal to the server 2 which, having received the transmission, records a code “XZ”, in the management data 30 (specifically 30-5) as shown by FIG. 9, for indicating a completion of the sale of the applicable commercial product by adding after the product code “00100A”, sales desire screen transmission code “002”, charging form screen transmission code “AB” and card number certification code “9” which are shown by the management data 30-4 of FIG. 9.

Then the server 2 configures display data of an e-mail for indicating the order completion and transmits the e-mail data to the Web browser. Having received the transmission, the Web browser displays a display for indicating the order completion in the display screen of the cellular phone 5 equipped with a camera.

As described above, the commercial product sales system according to the present invention enables a confirmation of a commercial product purchase by just transmitting photographed data by a person wanting to purchase the photographed desired commercial product out of a seemingly ordinary commercial product advertisement print which has been printed by a special printing method, followed by carrying out an input which is necessary for any mail-order shopping.

The sales company can provide a person wanting to purchase a product with trouble-free access just by distributing a seemingly ordinary commercial product advertisement print that is printed by a special printing method, therefore providing convenience in a sale of the commercial product being promoted.

And, since the special sign once photographed by a digital camera and image-recognized is stored within the digital camera as image data together with the commercial product image, a transmission of the image data to a friend or an acquaintance wanting to purchase the commercial product enables the person who is not necessarily the person photographing the image, having received the transmission, to place an order in the above described method, hence providing convenience of a busy person requesting a close friend, et cetera, to photograph out of the commercial product sales-use print 17 by informing him of a desired commercial product.

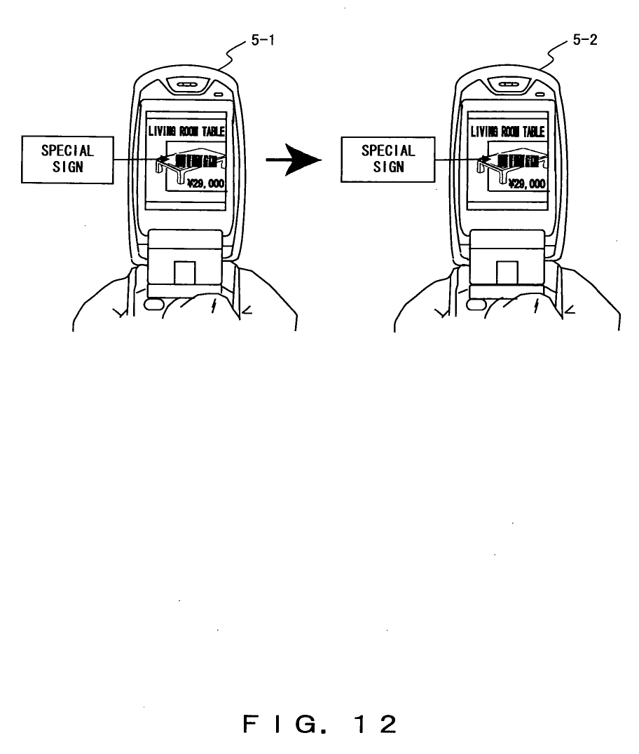

FIG. 12 shows a state of transferring such image data. The left drawing of FIG. 12 shows the cellular phone 5 (specifically 5-1) equipped with a camera photographing a desired commercial product (i.e., a living room table) out of the commercial product sales-use print 17, with the display screen showing the image-recognized special sign along with the commercial product image.

And the right drawing of FIG. 12 shows a cellular phone 5 (specifically 5-2) equipped with a camera which has received the data of the displayed image of the cellular phone 5 (5-1) equipped with a camera, which is shown on the left drawing of FIG. 12, transmitted therefrom.

The display screen of the cellular phone 5 (specifically 5-2) equipped with a camera also displays the same image-recognized special sign together with the commercial product image, indicating the fact that the memory comprised by the cellular phone 5 (specifically 5-2) equipped with a camera storing the data of the image of commercial product whose special sign has been image-recognized.

Note that although the above described embodiment has described a commercial product to be photographed as a commercial product advertisement print which is printed by a special printing method, an embodiment may be configured to allow a cellular phone equipped with a camera, et cetera, to photograph a special sign of a commercial product advertisement by a television screen for example displaying the special sign invisibly by overlapping or subliminally within the image on the television screen.

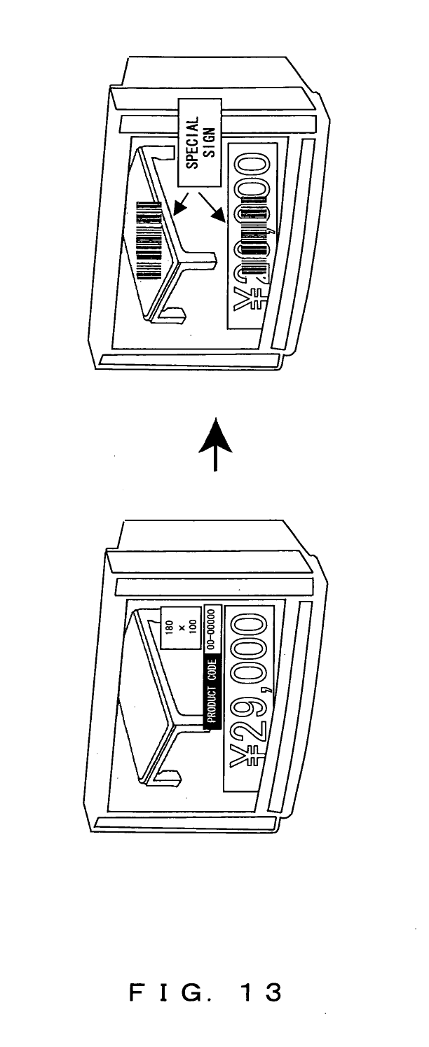

FIG. 13 exemplifies a commercial product advertisement attached by a special sign display in such a television screen. The left drawing of FIG. 13 is a display screen in which a television screen of a commercial product advertisement with a special sign display visually unrecognized, because it is embedded in the image by over lapping it subliminally and invisibly. That is, the display does not interfere with a viewing of the commercial product. ¥¥¥¥

Comparably, the right drawing of FIG. 13 is a television screen image displayed on the display screen of a cellular phone 5 equipped with a camera after photographing the usual screen shown by the left drawing of FIG. 13. As such, the cellular phone 5 equipped with a camera per se image-recognizes a subliminal and invisible special sign in the same way as in the case of the special printing on the commercial product sales-use print 17 as described above.

As described so far, the printing method according to the present invention provides convenience because a special printing can be carried out by a common printing apparatus capable of printing a color division printing by a subtractive three colors and black.

The commercial product information enabling a purchase and sale just by photographing a desired commercial product by using a digital photography apparatus out of a commercial product sales-use print, which merely looks just normal at a glance, and by transmitting the photographed data by way of a predetermined network is invisibly printed, and therefore it is convenient for printing a commercial product by maintaining a beauty as a commercial product sales-use print and by utilizing an ample space of a page thereof.

A purchase of a commercial product is enabled just by using a commercial product sales-use print of the present invention in the product sales system thereof, photographing a section in which the desired commercial product is formed by using an information terminal equipment comprising a camera and a transmission function, such as a cellular phone 5 equipped with a camera, and transmitting the imaged data in an electric transmission mode by way of a predetermined network.

Therefore, a procedure for manually keying in a URL is eliminated, and there is no need to search a site for commercial product information through a trial and error, thus enabling a confirmation just by comparing with a commercial product of the photographed print when reaching automatically at the commercial product site.

And even if a consumer is one who has difficulty in reading a fine or small characters or one who is unfamiliar with an operation of a computer, the consumer is enabled to easily place an order of a desired commercial product at the time of trying to purchase it, thus providing an extreme convenience.

The commercial product sales-use print according to the invention makes it possible to guide a terminal display screen of the transmitting person immediately to a relevant commercial product exhibit site by directly extracting the applicable commercial product information from the commercial product image data received as an electric signal and arrange the product delivery and charging by confirming the person wanting to purchase by an information exchange through a simple format by using the commercial product sales system of the invention. Thus, the described embodiments contribute to providing ease to an elderly person having a difficulty in reading a fine character or a consumer who is unaccustomed to a computer operation with an easy sales transaction of the commercial product.

Note, that it goes without saying, that although the above described embodiment is described by exemplifying the case of a printed image of an advertisement being a piece of furniture, such a printed image of an advertisement can be applied to the entirety of electronic and other material commerce by a print including office equipment and general home electric appliances, for example.

Also, although the photographing a printed image by a consumer is described as a cellular phone equipped with a camera, any equipment may be appropriate provided that the equipment comprises a digital camera, e.g., a digital camera, digital video recorder, PDA (personal digital assistant), et cetera, capable of photographing an image.

1. A printing method for a commercial product sales-use print comprising:
printing at least a visual image of a commercial product; and
printing commercial product information overlapping the visual image of the commercial product, which relates to the commercial product of the visual image, made up of a latent optical image that is almost invisible under visible light and becomes a visible image in a photograph of the printing.

2. The printing method for a commercial product sales-use print according to claim 1, further comprising:
forming a color image including black made up of three primary colors by three image forming units which form respective mono color images of each of the three primary colors by using a common printing apparatus comprising four image forming units for respectively forming four kinds of mono color images of three subtractive primary color inks and a black ink; and
printing said latent optical image with an ink for printing a latent optical image that is invisible under visible light and becomes a visible image in a photograph using an image forming unit for forming a mono color image by the black ink.

3. A printing method for a commercial product sales-use print comprising:
printing at least a visual image of a commercial product; and
printing a code for indicating commercial product information relating to the commercial product of the visible image by being embedded so as to be mixed with the pixels of the visible image of the commercial product.

4. The printing method for a commercial product sales-use print according to claim 3, wherein
said code for indicating said commercial product information is either a bar code or a two-dimensional code.

5. The printing method for a commercial product sales-use print according to claim 1, wherein
said commercial product information is the one including either or the entirety of the URL (uniform resource locator), advertisement name, advertisement date, or product code of the sales entity of said commercial product.

6. A commercial product sales-use print, printing comprising:
at least a visible image of a commercial product; and
a commercial product information, which relates to the commercial product of the visible image, made up of a latent optical image that is almost invisible under visible light and becomes a visible image in a photograph of the print, per image section of the print according to a category of the commercial product.

7. The commercial product sales-use print according to claim 6, wherein
said commercial product information by said latent optical image includes either or the entirety of the URL (uniform resource locator), advertisement name, advertisement date, or product code of the sales entity of said commercial product.

8. The commercial product sales-use print according to claim 6, wherein
said latent optical image is printed by overlapping with a visible image of said commercial product.

9. The commercial product sales-use print according to claim 6, wherein
said latent optical image is printed by overlapping with a visible printing of a price display which is printed together with said commercial product.

10. The commercial product sales-use print according to claim 6, wherein
said latent optical image is printed in an unprinted part within one image section.

11. The commercial product sales-use print according to claim 10, wherein
said unprinted part is the one adjacent to a visible printing of a size display which is printed with said commercial product.

12. A commercial product sales-use print, printing comprising:
at least a visible image of a commercial product; and
a code for indicating commercial product information relating to the commercial product of the visible image by being embedded so as to be mixed with the pixels of the visible image of the commercial product, per image section, the number of which is according to that of categories of commercial products.

13. The commercial product sales-use print according to claim 12, wherein
said code indicating said commercial product information is a bar code or a two-dimensional code.

14. The commercial product sales-use print according to claim 12, wherein
said commercial product information is the one including either or the entirety of the URL (uniform resource locator), advertisement name, advertisement date, or product code of the sales entity of said commercial product.

15. A commercial product sales system, comprising the procedures of:
photographing said image section which prints said desired commercial product that is contained by said commercial product-use prints according to claim 6;
placing an order of the photographed commercial product by converting the photographed image data into an electric signal and transmitting it by way of a predetermined telecommunication network; and
establishing the order by transmitting a response to image information of a prescribed format which is transmitted corresponding to the order of the commercial product by way of the telecommunication network.

16. The commercial product sales system according to claim 15, wherein
said response to image information of said prescribed format includes at least the name, street address and telephone number of a party sending the response.

17. The commercial product sales system according to claim 15, wherein
said photographing of said image section is carried out by a cellular phone equipped with a camera, a personal digital assistance (PDA) equipped with a camera and telecommunication function, or a digital camera; and
said transmission is carried out by a cellular phone equipped with a camera, a personal digital assistance (PDA) equipped with a camera, or a personal computer, comprising a telecommunication function, on which the image data is loaded from a digital camera.

18. A commercial product sales system comprising a server connected to a predetermined telecommunication network, wherein the server;
receives an electric signal transmitted by way of the telecommunication network as a result of converting image data, into the electric signal, through photographing said image section which prints said desired commercial product that is contained by either of said commercial product-use prints according to claim 6;
receives an order of a specified commercial product by specifying the commercial product in the photographed image section based on commercial product information contained by imaged data by processing the imaged data obtained from the received electric signal;
transmits image information of a prescribed format to a party transmitting the electric signal by way of the telecommunication network;
confirms that data responded by the transmitting party based on the transmitted image information by the prescribed format is the data correctly corresponding to the prescribed format; and
carries out the processing of a delivery instruction of the commercial product to the transmitting party and of charging the price of the commercial product based on the confirmed data.

19. The commercial product sales system according to claim 15, wherein
commercial product-use prints according to claim 6 are distributed to unspecified number of consumers or the ones wanting to be distributed.
